(19) United States
(12) Patent Application Publication
(10) Pub. No.: US 2024/0394110 A1
(43) Pub. Date: Nov. 28, 2024

(54) LATENCY-AWARE RESOURCE ALLOCATION FOR STREAM PROCESSING APPLICATIONS

(71) Applicant: NEC Laboratories America, Inc., Princeton, NJ (US)

(72) Inventors: Giuseppe Coviello, Robbinsville, NJ (US); Priscilla Benedetti, Perugia (IT); Kunal G. Rao, Monroe, NJ (US); Srimat Chakradhar, Manalapan, NJ (US)

(21) Appl. No.: 18/672,464

(22) Filed: May 23, 2024

Related U.S. Application Data
(60) Provisional application No. 63/469,038, filed on May 25, 2023.
(60) Provisional application No. 63/597,422, filed on Nov. 9, 2023.

(51) Int. Cl. G06F 9/50; G06F 11/34

(52) U.S. Cl. CPC G06F 9/5044; G06F 11/3409

(57) ABSTRACT

Systems and methods are provided for dynamically adjusting computing resources allocated to tasks within a stream processing application, including initiating monitoring of application-specific characteristics for each task, the characteristics including processor (CPU) usage and processing time, assessing resource allocation needs for each task based on the monitored characteristics to determine discrepancies between current resource allocation and optimal performance requirements, and implementing exploratory resource adjustments by incrementally modifying CPU resources allocated to a subset of tasks and analyzing an impact of the exploratory resource adjustments on task performance metrics. Optimal resource allocations are determined for each task using a regression model that incorporates historical and real-time performance data, and the optimal resource allocations are applied to the tasks to minimize processing time and maximize resource use efficiency. The optimal resource allocations are iteratively updated in response to changes in task characteristics or application demands.

### RELATED APPLICATION INFORMATION

This application claims priority to U.S. Provisional App. No. 63/469,038, filed on May 25, 2023; and U.S. Provisional App. No. 63/597,422, filed on Nov. 9, 2023, the contents of each of which are incorporated herein by reference in their entirety.

### BACKGROUND

### Technical Field

The present invention relates to dynamic resource management and real-time video processing in distributed computing systems, and more particularly to a system and method for optimizing processor (CPU) resource allocation across microservices in distributed computing systems based on real-time analytics of video data to enhance operational efficiency and response times by dynamically allocating sufficient processing power and reducing latency for application microservices.

### Description of the Related Art

In the field of real-time video processing and distributed computing systems, traditional approaches have focused on static resource allocation strategies, which often fall short in dynamic environments where video data inputs and processing demands can vary significantly. Such conventional systems allocate fixed resources per task without considering fluctuations in computational load, leading to inefficient processor (CPU) usage and increased latency. This is particularly problematic in applications requiring rapid response and high accuracy, such as public safety monitoring, facial recognition, and traffic management. Existing methods cannot adequately adapt to changing conditions in real-time, resulting in underutilization of resources during low demand periods and potential system overload during peak times. Furthermore, these systems lack the capability to analyze and respond to real-time analytics of video data, which is particularly useful for optimizing performance and operational efficiency in, for example, surveillance, facial recognition, and traffic control scenarios. Thus, there is a need for an adaptive solution that can dynamically manage CPU resources across microservices to provide optimal system performance by adjusting to the demands of video stream processing applications in real-time.

### SUMMARY

According to an aspect of the present invention, a method is provided for dynamically adjusting computing resources allocated to tasks within a stream processing application, including initiating monitoring of application-specific characteristics for each task, the characteristics including processor (CPU) usage and processing time, assessing resource allocation needs for each task based on the monitored characteristics to determine discrepancies between current resource allocation and optimal performance requirements, and implementing exploratory resource adjustments by incrementally modifying CPU resources allocated to a subset of tasks and analyzing an impact of the exploratory resource adjustments on task performance metrics. Optimal resource allocations are determined for each task using a regression model that incorporates historical and real-time performance data, and the optimal resource allocations are applied to the tasks to minimize processing time and maximize resource use efficiency. The optimal resource allocations are iteratively updated in response to changes in task characteristics or application demands.

According to another aspect of the present invention, a system is provided for dynamically adjusting computing resources allocated to tasks within a stream processing application. The system includes a memory storing instructions that when executed by a processor device, cause the system to initiate monitoring of application-specific characteristics for each task, the characteristics including processor (CPU) usage and processing time, assess resource allocation needs for each task based on the monitored characteristics to determine discrepancies between current resource allocation and optimal performance requirements, and implement exploratory resource adjustments by incrementally modifying CPU resources allocated to a subset of tasks and analyzing an impact of the exploratory resource adjustments on task performance metrics. Optimal resource allocations are determined for each task using a regression model that incorporates historical and real-time performance data, and the optimal resource allocations are applied to the tasks to minimize processing time and maximize resource use efficiency. The optimal resource allocations are iteratively updated in response to changes in task characteristics or application demands.

According to another aspect of the present invention, a computer program product is provided for dynamically adjusting computing resources allocated to tasks within a stream processing application, including instructions for initiating monitoring of application-specific characteristics for each task, the characteristics including processor (CPU) usage and processing time, assessing resource allocation needs for each task based on the monitored characteristics to determine discrepancies between current resource allocation and optimal performance requirements, and implementing exploratory resource adjustments by incrementally modifying CPU resources allocated to a subset of tasks and analyzing an impact of the exploratory resource adjustments on task performance metrics. Optimal resource allocations are determined for each task using a regression model that incorporates historical and real-time performance data, and the optimal resource allocations are applied to the tasks to minimize processing time and maximize resource use efficiency. The optimal resource allocations are iteratively updated in response to changes in task characteristics or application demands.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a method for dynamically adjusting computing resources for stream processing applications, in accordance with embodiments of the present invention;

FIG. 3 is a diagram illustratively depicting a method for dynamically adjusting computing resources for microservices in video analytics pipelines, in accordance with embodiments of the present invention;

FIG. 4 is a diagram illustratively depicting a method for dynamically monitoring application-specific characteristics and automatically optimizing computing resource allocation for particular tasks within stream processing applications, in accordance with embodiments of the present invention;

FIG. 5 is a diagram illustratively depicting a system and method for dynamically monitoring and adjusting computing resource allocation in video analytics pipelines, in accordance with embodiments of the present invention;

FIG. 6 is a diagram illustratively depicting a method for dynamically managing computing resources across various processing nodes in a video analytics platform, in accordance with embodiments of the present invention;

FIG. 7 is a diagram illustratively depicting a system and method for dynamically managing computing resources in a distributed microservices architecture by Latency-Aware Resource Allocation (LARA), in accordance with embodiments of the present invention;

FIG. 8 is a diagram illustratively depicting a method for greedy processor (CPU) updating for dynamically managing computing resources within a microservice architecture, in accordance with embodiments of the present invention;

FIG. 9 is a diagram illustratively depicting a method for exploratory CPU updating for dynamically managing computing resources within a microservice architecture, in accordance with embodiments of the present invention;

FIG. 10 is a diagram illustratively depicting a method for processing time minimization and CPU allocation optimization for dynamically managing computing resources within a microservice architecture, in accordance with embodiments of the present invention;

FIG. 11 is a diagram illustratively depicting a high-level view of a method for dynamically optimizing allocation of CPU resources in various real-world environments responsive to specific requirements and characteristics of particular microservices, in accordance with embodiments of the present invention; and

FIG. 12 is a diagram illustratively depicting a high-level view of a system for dynamically monitoring and adjusting computing resource allocation within a microservice architecture, in accordance with embodiments of the present invention.

### DETAILED DESCRIPTION

In accordance with embodiments of the present invention, systems and methods are provided for dynamically managing processor (CPU) resources across microservices within distributed computing environments, particularly enhancing real-time video processing applications such as traffic management, public safety monitoring, and automated surveillance systems. In various embodiments, the present invention can include implementing a set of strategies that not only ensures that each microservice retains adequate CPU resources but also minimizes latency by optimizing the processing time and CPU allocations for each involved microservice. This can be achieved by performing real-time analytics of video data to dynamically adjust CPU allocations for optimal performance, thereby enhancing operational efficiency and responsiveness.

The present invention can include a sophisticated architecture that includes various specialized components such as a metrics collector device, a CPU usage and processing time evaluator, and a Latency-Aware Resource Allocation (LARA) device, among others. Each component can interact seamlessly within a system integration bus, ensuring that real-time data regarding system performance and resource usage is efficiently processed and acted upon. The invention can utilize a regression-based CPU allocator that predicts and adjusts CPU distributions based on the analytics received, ensuring optimal resource utilization and system performance. The innovative nature of the system extends beyond conventional static resource allocation methods by adapting to changing conditions in real-time, which is crucial for maintaining system integrity and performance in environments with highly variable and unpredictable workloads. Furthermore, the system's capabilities include sophisticated tracking and recognition features that support a wide range of applications, enhancing its utility and applicability in critical real-time processing scenarios. Through this integrated approach, the invention addresses the existing challenges in the field by providing a flexible, efficient, and responsive solution that can significantly improve the management and execution of distributed video processing tasks, in accordance with aspects of the present invention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

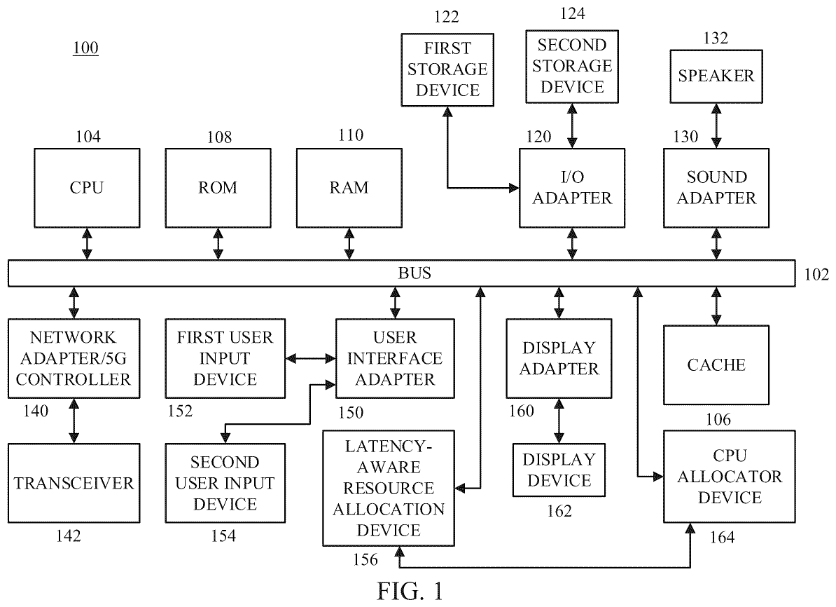

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a predictor device 164 for input text processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. A Latency-Aware Resource Allocation (LARA) device 156 can be utilized for decision-making related to resource allocation and can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The LARA 156 can be utilized for decision-making related to resource allocation, and can work in conjunctions with a CPU allocator device 164 which can adjust CPU allocations dynamically according to the analysis by the LARA 156, each of which can be operatively connected to the system 100 for any of a plurality of tasks (e.g., CPU allocation, load balancing, system performance optimizer, etc.), in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

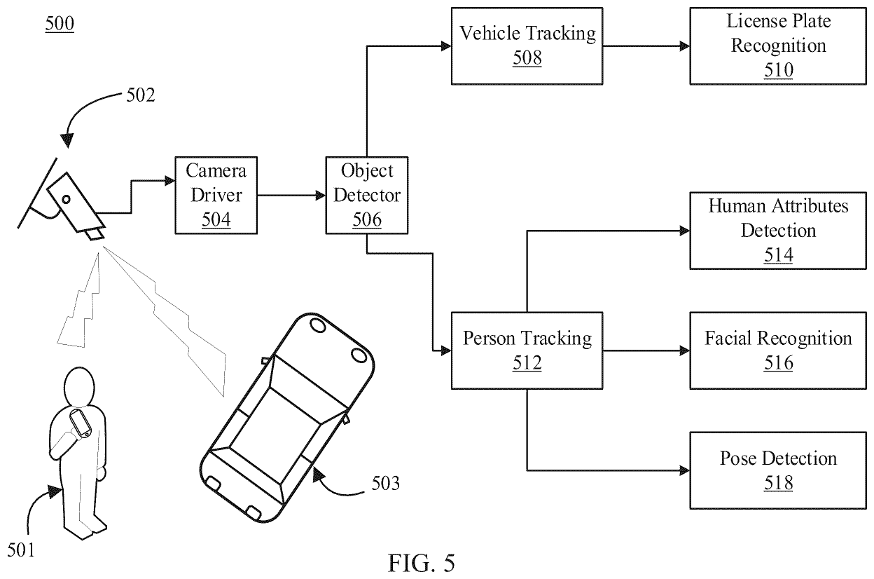

Moreover, it is to be appreciated that systems 500, 600, and 1200, described below with respect to FIGS. 5, 6, and 12, respectively, are systems for implementing respective embodiments of the present invention. Part or all of processing system 100 may be implemented in one or more of the elements of systems 500, 600, and 1200, in accordance with aspects of the present invention.

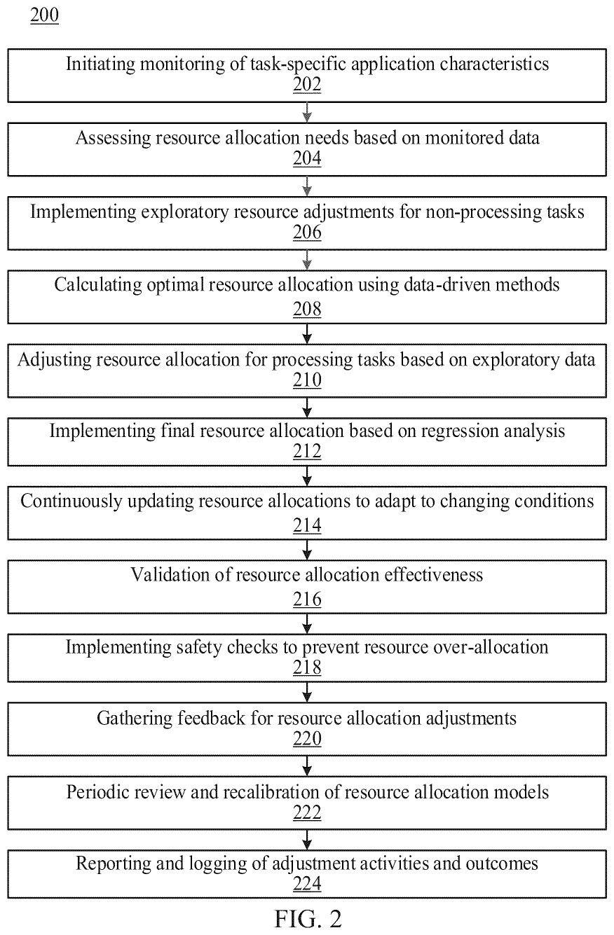

Further, it is to be appreciated that processing system 100 may perform at least part of the methods described herein including, for example, at least part of methods 200, 300, 400, 500, 600, 700, 800, 900, 1000, and 1100, described below with respect to FIGS. 2, 3, 4, 5, 6, 7, 8, 9, 10, and 11, respectively. Similarly, part or all of systems 500, 600, and 1200 may be used to perform at least part of methods 200, 300, 400, 500, 600, 700, 800, 900, 1000, and 1100 of FIGS. 2, 3, 4, 5, 6, 7, 8, 9, 10, and 11, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a diagram showing a method 200 for dynamically adjusting computing resources for stream processing applications, is illustratively depicted in accordance with embodiments of the present invention.

In various embodiments, in block 202, continuous monitoring of various characteristics specific to each task within a stream processing application can be performed. These characteristics can include but are not limited to CPU usage, processing speed, and memory consumption. Monitoring can include capturing real-time data using embedded sensors or monitoring tools integrated within the application infrastructure. The data collected provides a foundational understanding of each task's resource consumption, which can be utilized for making informed resource allocation decisions.

Block 204 involves assessing the current resource allocation by analyzing the monitored data to determine if adjustments are necessary. This assessment can utilize algorithms to compare current resource usage against optimal usage patterns derived from historical performance data. If discrepancies are detected (e.g., over or under-utilization of resources), the system can flag these tasks for potential resource reallocation, and the application can adapt to dynamic conditions without human intervention, in accordance with aspects of the present invention. In block 206, exploratory resource adjustments can be implemented for tasks that do not directly process data but support data processing tasks, such as data routing or load balancing. Adjustments can be executed in a controlled environment to evaluate potential impacts on system performance without affecting the live environment. This can involve simulations or isolated testing to predict the outcomes of resource adjustments before they are applied in a production setting.

In block 208, optimal resource allocation can be determined using advanced data-driven methods, such as machine learning algorithms or statistical models, that analyze trends and patterns from the data collected. The system can utilize these models to predict future resource requirements and to devise a resource allocation strategy that optimizes application performance, minimizes latency, and reduces resource wastage. In block 210, resource allocation for processing tasks can be adjusted based on insights gained from the exploratory data. This can include applying the tested adjustments to the live environment, carefully monitoring the impact, and tweaking the resources dynamically. Resource adjustments can be fine-tuned to ensure that each processing task receives an adequate amount of resources to meet its performance targets without exceeding computing and/or user-defined limits.

Block 212 involves implementing final resource allocations based on a regression analysis that correlates resource input with processing output. This step employs a sophisticated mathematical model to establish a predictive relationship between allocated resources and task performance, ensuring that resource allocation is both efficient and predictive of future requirements. In block 214, resource allocations can be iteratively, continuously updated in response to changing application demands and external conditions. This dynamic adjustment can be supported by a feedback loop that incorporates new data into the resource allocation models in real-time, allowing the system to adapt quickly to fluctuations in data volume, task complexity, or other environmental factors.

Block 216 validates the effectiveness of resource allocation strategies by comparing the performance outcomes with the expected benchmarks. This validation process can include detailed performance analytics to ascertain whether the adjustments have led to improvements in processing efficiency, reduced latency, and optimal resource usage. The results of this validation can be used to further refine the resource allocation algorithms. In block 218, a series of safety checks designed to prevent the over-allocation of resources, which could lead to system instability or inefficiencies, can be implemented. These checks can involve setting thresholds based on maximum allowable resource usage, monitoring for any signs of resource saturation, and preemptively reallocating resources to prevent overload conditions.

Block 220 involves gathering feedback from the system's users and automated reports to assess the impact of recent resource allocation adjustments. This feedback can be utilized for identifying any issues that may not be apparent through system monitoring alone and for ensuring that the system remains responsive to the needs of its users. In block 222, periodic reviews and recalibrations of the resource allocation models can be conducted to ensure their accuracy and relevance over time. This can involve analyzing the latest data, comparing it against historical models, and adjusting the models to reflect new insights or changes in application architecture. Block 224 ensures that all resource adjustment activities and their outcomes are thoroughly documented in a detailed log. These logs can include timestamps, nature of the adjustments, rationale behind decisions, and observed impacts on system performance. This documentation can be utilized for compliance, auditability, and for providing insights during review processes, in accordance with aspects of the present invention.

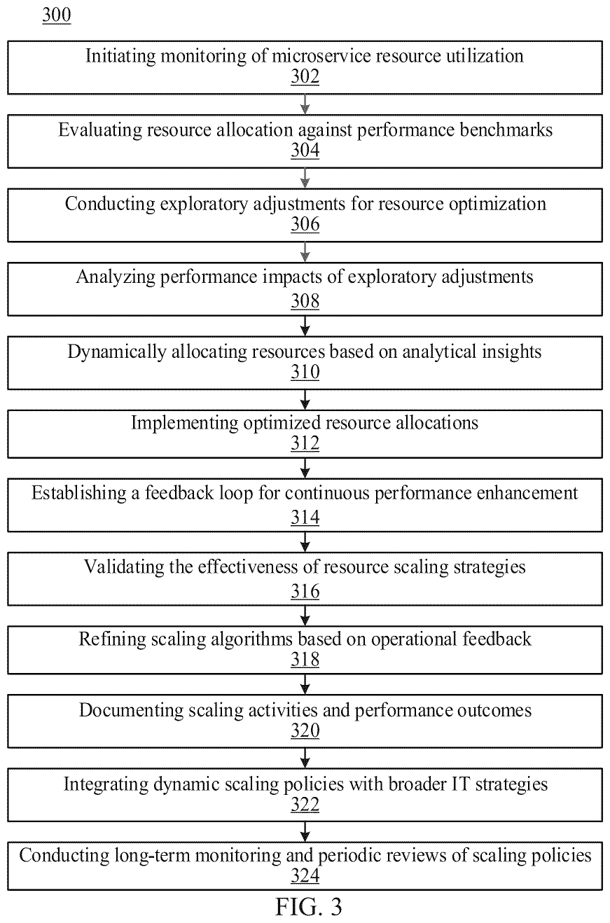

Referring now to FIG. 3, a diagram showing a method 300 for dynamically adjusting computing resources for microservices in video analytics pipelines, is illustratively depicted in accordance with embodiments of the present invention.

In various embodiments, in block 302, continuous monitoring of resource utilization across microservices can be initiated. This monitoring can include the collection of data on CPU usage, memory usage, network traffic, and other system resources critical to the operation of video analytics applications. Monitoring tools or integrated software agents can perform data collection at predetermined intervals to provide a comprehensive view of resource consumption patterns. Block 304 involves evaluating current resource allocations against established performance benchmarks and application requirements. This evaluation can help identify discrepancies between allocated resources and actual needs based on the workload dynamics. Adjustments can then be suggested and/or automatically implemented to enhance system performance and/or to rectify resource inefficiencies.

In block 306, exploratory adjustments to resource allocations can be conducted to gauge their impact on application performance. This process can involve simulation models or small-scale real-world deployments where resources such as CPU and memory are variably adjusted. These exploratory adjustments can be utilized for determining potential benefits of different resource allocation strategies without fully implementing these changes in a live environment. IN block 308, an impact of exploratory adjustments can be analyzed using various performance indicators such as processing speed, error rates, and service downtime. Analysis tools can generate reports highlighting the outcomes of different resource configurations, which can be used to refine the resource management strategy. In block 310, dynamic allocation of resources based on insights gained from the analysis can be implemented. Algorithms may utilize historical data and predictive models to adjust resource levels automatically. These adjustments can be tailored to respond to real-time changes in workload or to preemptively scale resources in anticipation of increased demand.

Block 312 involves implementing optimized resource allocations as determined by the dynamic scaling system. This step ensures that each microservice receives an appropriate amount of resources, adjusted to optimize operational efficiency and to meet performance targets without over-provisioning. In block 314, a feedback loop can be established to continuously enhance performance. This loop can integrate monitoring, analysis, and adjustment phases to maintain optimal performance. Real-time data feeds back into the system, allowing for ongoing adjustments that can adapt to evolving application needs and workload fluctuations. Block 316 focuses on validating the effectiveness of resource scaling strategies through rigorous testing and performance evaluations. Validation processes can compare expected outcomes with actual performance metrics to ensure that scaling strategies are effectively enhancing application responsiveness and efficiency.

In block 318, scaling algorithms can be refined based on feedback from operational data. This refinement process can involve adjusting parameters within the algorithms to better match the resource demands of the application, thereby reducing instances of resource over-allocation or under-utilization. Block 320 involves documenting all scaling activities and their respective performance outcomes. Documentation can include detailed logs of when resources were adjusted, the rationale for adjustments, and the impact on system performance. This documentation can be utilized for a variety of purposes, including, for example, regulatory compliance, auditing purposes, system updating, CPU allocation, etc., in accordance with aspects of the present invention. In block 322, dynamic scaling policies can be integrated with broader IT management and governance strategies. This integration ensures that resource scaling is not only reactive to immediate needs but also aligned with long-term organizational goals and IT infrastructure planning. In block 324, long-term monitoring and periodic reviews of scaling policies can be conducted to ensure these policies remain effective as technology and business needs evolve. Regular assessments can help identify areas for improvement in the scaling strategy, ensuring that the system continues to meet the operational demands effectively, in accordance with aspects of the present invention.

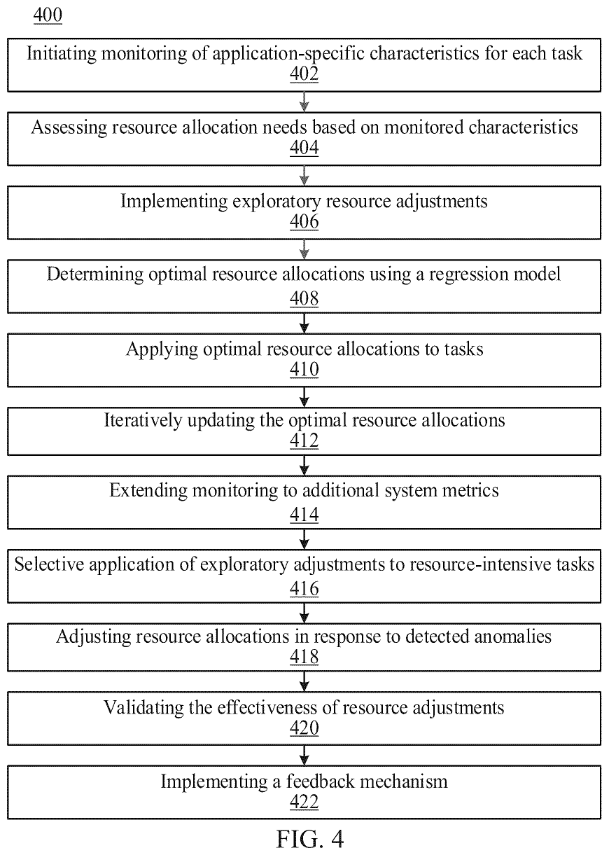

Referring now to FIG. 4, a diagram showing a method 400 for dynamically monitoring application-specific characteristics and automatically optimizing computing resource allocation for particular tasks within stream processing applications, is illustratively depicted in accordance with embodiments of the present invention.

In various embodiments, in block 402, continuous monitoring of application-specific characteristics for each task within a stream processing application can be initiated. This monitoring can involve the collection of various performance metrics, such as CPU usage, processing time, and other relevant operational parameters. Data can be gathered through sensors or software integrated into the system, which continuously track the performance and resource utilization of each task, ensuring that a comprehensive dataset is available for further analysis and decision-making processes. In block 404, an assessment of resource allocation needs for each task can be conducted based on the characteristics monitored. This process can involve detailed analysis using advanced statistical methods and machine learning algorithms to identify patterns of resource use. This can be used to determine discrepancies between the current resource allocations and what would be required for optimal performance, allowing for predictive adjustments that enhance overall system efficiency.

In block 406, exploratory adjustments to the allocation of resources, such as CPU and memory, can be made. This can involve incrementally increasing or decreasing resource allocations to a selected subset of tasks and observing the effects on system performance. Such exploratory changes can help in understanding the impact of different resource levels on task efficiency and throughput, forming a basis for more refined adjustments. In block 408, optimal resource allocations for each task can be determined using a regression model that integrates both historical and real-time performance data. The model (e.g., a quadratic polynomial regression model), can be designed to predict task performance as a function of various levels of resource allocation. This model can dynamically adapt its parameters to accommodate changes in task behavior or system demands, ensuring that the resource allocations are always tuned to current conditions.

In block 410, the resource allocations determined to be optimal can be applied to the tasks. This step can involve automated systems configuring the resource distribution across the processing environment to optimize performance metrics such as processing time and resource utilization. The application of these settings can be monitored and adjusted in real-time, ensuring that the system operates within the desired efficiency parameters. In block 412, the optimal resource allocations can be iteratively updated in response to ongoing changes in task characteristics or overall system demands. This can involve a continuous feedback loop where system performance is regularly assessed and resource allocations are adjusted to maintain or enhance performance, adapting dynamically to new data and operational conditions.

In block 414, the scope of monitoring can be extended to include additional system metrics such as memory consumption and network usage. By broadening the range of monitored characteristics, a more detailed understanding of the system's operational needs can be developed. This comprehensive monitoring can facilitate more precise adjustments to resource allocations, enhancing the responsiveness and efficiency of the application. In block 416, exploratory resource adjustments can be applied selectively to tasks identified as resource-intensive. By focusing on these high-demand areas, resource utilization can be optimized more effectively, ensuring that more critical tasks have adequate resources without unnecessarily allocating excessive resources to less demanding tasks.

In block 418, resource allocations can be adjusted in response to anomalies detected in application performance that deviate from predefined thresholds. This proactive approach can involve dynamically scaling resources up or down based on real-time data, helping to stabilize performance and prevent service degradation. In block 420, the effectiveness of resource adjustments can be validated by comparing performance metrics before and after adjustments against predetermined benchmarks. This validation process can help confirm that the resource adjustments are having the intended effect on system performance, providing a basis for further refinement. In block 422, a feedback mechanism can be implemented to adjust the determined optimal resource allocations based on the satisfaction level of previous adjustments. This mechanism can allow the system to learn from past actions and continuously refine its approach to resource management, enhancing overall application performance, in accordance with aspects of the present invention.

Referring now to FIG. 5, a diagram showing a system and method 500 for dynamically monitoring and adjusting computing resource allocation in video analytics pipelines, is illustratively depicted in accordance with embodiments of the present invention.

In various embodiments, the system and method 500 can include a system architecture engineered for advanced real-time video analysis. The diagram showcases an integrated network of components optimized for precise and efficient processing of dynamic interactions between humans, vehicles, and other objects within the environment, as captured through sophisticated video surveillance technology.

In various embodiments, in block 502, a camera (e.g., fixed video camera, camera equipped with automated pan and tilt controls, etc.) can dynamically adjust its field of view to maintain focus on active subjects like the person in block 501 or the vehicle in block 503. This capability enables continuous monitoring and detailed recording of subjects' movements and interactions, which can be utilized for comprehensive scene analysis and real-time response in security and traffic management systems. The camera can be further equipped to handle various environmental conditions, providing high-resolution video suitable for detailed analytics. This video data can serve as the primary input for the system, continuously feeding real-time video to the subsequent processing stages, in accordance with aspects of the present invention.

In block 501, an exemplary human subject can be recognized and analyzed within the system's operational environment. The system 500 can be implemented for detecting and tracking individual movements and actions of a human subject 501, providing data which can be utilized for applications like behavior analysis, security surveillance, and safety monitoring. The human subject's activities can also trigger specific responses in the system, such as targeted camera operations or alert notifications. In block 503, a moving or stationary object (e.g., vehicle) can be detected and its movements within the camera's viewing range can be tracked. This data captured for the object 503 can be utilized for applications requiring traffic flow analysis, parking management, and automated law enforcement measures like speed detection and traffic violation enforcement. In block 504, a camera driver can manage the operational parameters of the camera hardware, ensuring that video data is captured effectively and transmitted in a suitable format for processing. The driver can handle various camera settings, including focus, exposure, and zoom, to optimize video quality for object detection and tracking processes.

In block 506, an object detector can analyze incoming video feeds to identify and classify various objects and entities within the scene. This component can utilize advanced image processing algorithms, potentially based on machine learning techniques, to accurately detect and differentiate between diverse objects such as vehicles, pedestrians, and other relevant items. In block 508, vehicle tracking can be conducted to monitor the trajectories and behaviors of detected vehicles. This function is vital for traffic analysis and security applications, providing data that can inform traffic light control, congestion management, and incident response strategies. In block 510, license plate recognition can extract and process vehicle license plate information using optical character recognition technology. This capability can be utilized in a variety of applications, including, for example, automated toll collection, parking access control, vehicle tracking in law enforcement scenarios, etc., in accordance with aspects of the present invention.

In block 512, person tracking can track the movement and activities of individual persons, such as the human subject represented in block 501. This technology can be utilized for security and safety systems, enabling continuous surveillance and activity logging for individuals within protected or monitored areas. In block 514, human attributes detection can identify specific features and characteristics of persons within the video feed, such as clothing, accessories, or even behavioral patterns. This information can be utilized in, for example, identity verification, crowd monitoring, profiling in security-sensitive environments, etc. In block 516, facial recognition can identify and verify individuals based on facial features captured through the video system. This module can be linked to databases containing known individuals for security purposes, access control, or for locating persons of interest in public spaces.

In block 518, pose detection can analyze the postures and physical orientations of individuals, providing insights into their actions and interactions. This functionality can be used in advanced monitoring systems, such as detecting unusual or emergency situations, and in interactive applications where user gestures control system responses. The system architecture illustrated in FIG. 5 can integrate each component via a robust communication framework that ensures real-time data processing and interaction across the system. This setup enables seamless operation of various applications, including, for example, surveillance and monitoring functions, with each component contributing to an overarching system capability which provides enhanced safety, security, and operational efficiency in dynamic environments, in accordance with aspects of the present invention.

In the exemplary embodiment shown in FIG. 5, pipelines for four video analytics applications are presented for ease of illustration, noting that any number of analytics applications and pipelines can be utilized in the present invention. The exemplary pipelines are for license plate recognition 510, human attributes detection 514, facial recognition 516, and pose detection 518. For license plate recognition 510, in smart transportation systems, it is often imperative that a license plate of a vehicle is quickly identified and recognized as a vehicle is in motion. The response time for this can be important, especially for example, if someone is missing or kidnapped and an alert is issued to search for a car with a particular license plate.

With regard to human attributes detection 514, this can include detecting various features for a human, including the color of the clothes they are wearing, the hair style they have (e.g. brown long or blonde short), etc. Such real-time detection and analysis of attributes can be especially useful in, for example, identifying a missing child in a large public area (e.g., airport, train station, mall, etc.), as the sooner the attributes are detected, the faster the locating and recovery of the missing child.

With regard to facial recognition 516, for surveillance applications, it can be important to watch individuals entering a particular facility in real-time to prevent unauthorized individuals or known criminals from gaining access. If such individuals are identified, then security personnel can be notified immediately, so that they can stop the prohibited individual from entry and/or detain the individual by law enforcement.

With regard to pose detection 518, the detection of a pose of individuals (e.g., standing, walking, falling, raising hand, moving fingers, etc.) can be particularly useful for determining the potential actions that the individual may perform, and if a person is performing any unsafe action, either knowingly or unknowingly, the present invention can be utilized to quickly identify these unsafe actions and alert the individual regarding the unsafe situation in real time, in accordance with aspects of the present invention.

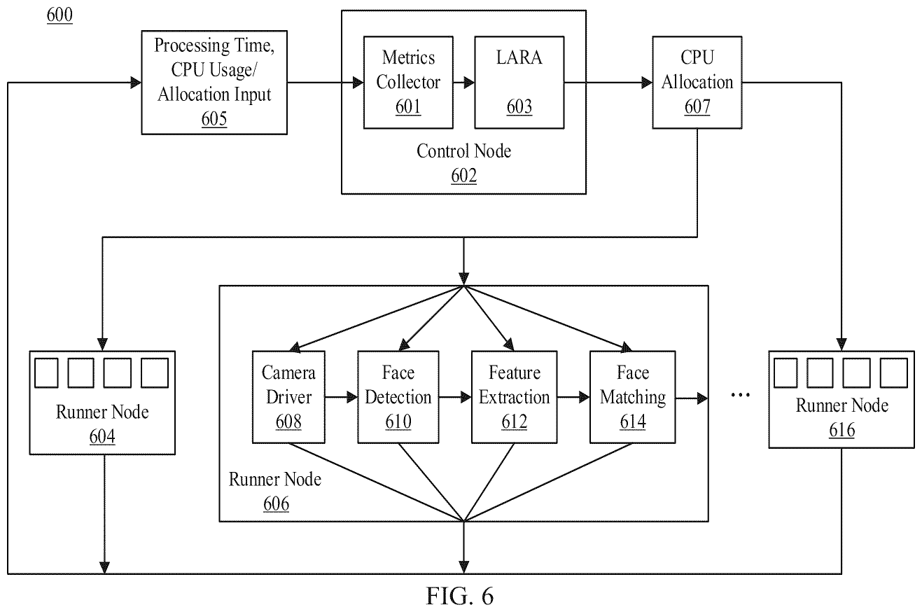

Referring now to FIG. 6, a diagram showing a system and method 600 for dynamically managing computing resources across various processing nodes in a video analytics platform, is illustratively depicted in accordance with embodiments of the present invention. In various embodiments, the system and method 600 can dynamically manage computing resources across various processing nodes in a video analytics platform by intelligently allocating CPU resources among multiple microservices based on real-time processing demands and resource utilization metrics. This configuration provides optimized processing of video data through enhanced resource allocation strategies that minimize latency and maximize processing efficiency.

In various embodiments, a control node 602, which can include a metrics collector 601 and a Latency-Aware Resource Allocation (LARA) device 603, can be utilized as a central processing unit for decision-making related to resource allocation. This node can analyze the data collected by the Metrics Collector 601 to make informed decisions about resource distribution across the system. The LARA 603 can use algorithms based on historical data and predictive modeling to dynamically adjust resources in anticipation of changing processing loads.

In block 601, a metrics collector can be implemented to continuously gather and analyze data related to the performance of various microservices involved in the video analytics process. This can include metrics such as CPU usage, memory usage, and processing time. The metrics collector can be utilized to aggregate data from multiple sources within the system, ensuring a comprehensive understanding of resource utilization which can be utilized for optimizing system performance. In block 603, LARA, which can be part of the Control Node, can specifically handles the logic for adjusting resources dynamically. This can include calculating optimal CPU allocations for each microservice using sophisticated algorithms that consider current and predicted future states. Such utilization of LARA can effectively reduce processing time and adjust resources in real-time to respond to fluctuating demands without human intervention, in a accordance with aspects of the present invention.

In block 605, inputs regarding processing time, CPU usage, and CPU allocation recommendations are fed into the system. This input can be derived from real-time monitoring and historical performance analysis, serving as a guideline for LARA to make adjustments. These inputs help in making precise and timely resource allocation decisions to optimize system performance continuously. In block 607, CPU Allocation can be performed according to directives from the Control Node on how to distribute or reallocate CPU resources among the Runner Nodes. This block can adjust CPU allocations dynamically based on the analysis performed by LARA, ensuring that each microservice has adequate resources to perform efficiently without wastage. This dynamic allocation can significantly enhance the system's ability to handle high-load scenarios and improve overall application responsiveness.

Runner nodes 604, 606, 616 can be included, and represent the distributed architecture of the system where actual data processing occurs. Each runner node can host multiple microservices that perform various functions from video input processing to advanced analytics such as face detection and feature extraction. These nodes can be scaled horizontally to increase processing capacity and can be utilized for maintaining the system's performance and reliability by ensuring that processing loads are balanced across the available resources. Microservices hosted by the runner nodes can be any of a plurality of applications and application types, but for illustrative purposes, microservices will be described with reference to a camera driver 608, face detection 610, feature extraction 612, and face matching 614, noting that these are exemplary and a plurality of other microservices can be utilized in accordance with aspects of the present invention.

The camera driver 608 within a runner node 606 can handle the initial processing of video data from cameras. This driver can preprocess the video stream to adjust formats, frame rates, or resolutions before passing it on to other microservices for further processing. The camera driver 608 can be utilized for ensuring that the video data is in the proper state for accurate analytics. In block 610, the face detection microservice can analyze the preprocessed video to identify human faces. This can involve using deep learning models that can detect faces under various conditions and angles, which can be effectively utilized for applications requiring identification or demographic analysis. In block 612, the feature extraction microservice can process the detected faces to extract distinctive features. This can include aspects such as facial landmarks, expressions, and other identifiable attributes that are used for comparing and analyzing faces in subsequent processes. In block 614, the face matching microservice can compare extracted features against known profiles or databases to identify or verify individuals. This microservice can use complex algorithms to perform matches with high accuracy, which is particularly useful for real-time security applications such as surveillance or access control, in accordance with aspects of the present invention.

In an exemplary embodiment, a stream analytics application can include analyzing live videos to derive the “pose” (e.g., standing, sitting, lying down etc.) of the people seen by the camera. Each single operation can be implemented as a standalone microservice, and a microservice can operate on the output of the previous microservices. The present invention can utilize varying strategies depending on the type of analyzed microservices (e.g., differentiating between non-processing and processing components. For example, the camera-driver 608 can be referred to as a non-processing component, which produces messages to be processed by the interconnected processing components, such as the analytics-units (AUs) (e.g., Face Detection and Matching 609 and Pose Detection 610, etc.), which can perform the core analytics tasks for deriving insights from the video streams.

In various embodiments, the start of every cycle, LARA can collect the list of currently running microservices from the “Metrics collector” and iterates through all of them one by one. During each iteration, a specific microservice is analyzed to determine if the allocated CPU resources to the microservice needs to be changed. In order to do so, LARA first collects and notes down the currently allocated CPU and the processing time for the microservice. Then, LARA checks if the CPU usage (obtained from “Metrics collector” for the microservice) is over a pre-configured value (given by targetCPUUtilization). If the CPU usage is over, LARA starts performing “Greedy CPU update”, wherein the amount of CPU resources allocated to the microservice is increased until the CPU usage goes below the threshold. In order to perform this “greedy” update, LARA assigns the new CPU resource to be allocated as min (CPU usage, max AllocatableCores). Here, CPU usage is the current CPU utilization and maxAllocatableCores is the maximum CPU allocatable for the microservice, which can be configured by the system administrator. If the CPU usage is less than minAllocatableCores, then the assigned CPU cores is bumped up to minAllocatableCores. In various embodiments, only one update is performed every cycle and then this microservice is checked again at the next cycle.

If the CPU Usage is below target CPU Utilization, then LARA can initially delete the expired data points (e.g., the data points corresponding to the microservice which have been persisted for a time duration which is greater than timeToLive configuration parameter). Next, LARA can sort the available data points based on when they were collected and removes all oldest data points which are in excess of the number of data points. Once, the data points are cleaned up, LARA can determine whether there are at least a threshold number of data points (e.g., three data points) available for the microservice. If less than the threshold amount (e.g., three points) are collected, LARA assigns, if missing, the minAllocatableCores, maxAllocatableCores and a point exactly in between these two (middleAllocatableCores).

When a threshold number is met or exceeded (e.g., three or more data points are collected), LARA starts to either perform random CPU update or regression-based CPU update based on a probability (e.g., predefined or user-set). As an illustrative example, assume that LARA can start with a probability of 50% and chooses either one of them with equal probability. Then, as the number of data points collected increase, LARA performs regression-based CPU update with a higher probability and this can be raised all the way up to 99%. Thus random CPU update can be triggered less often as more data points are collected.

For regression-based CPU update, LARA can leverage all the previously collected data points to learn and estimate a function, which binds the CPU Allocation (x) and Processing time (ƒ(x)). For this, LARA uses standard polynomial regression [17] technique. If the estimated function ƒ(x)=b₁+b₂x+b₃x² is convex and xₘᵢₙ|ƒ(xₘᵢₙ)≤ƒ(x)∀x>0, the next CPU Allocation performed by LARA is as follows:

$$\{ \begin{matrix}minAllocatableCores , & {x}_{min} < minAllocatableCores \\ maxAllocatableCores , & {x}_{min} > minAllocatableCores \\ {x}_{min} , & otherwise\end{matrix}$$

In the above equation, xₘᵢₙ is the minimum number of CPU cores on the fitted curve that results in the least processing time for the microservice. In this “Regression-based CPU update”, LARA can either increase or decrease the amount of CPU resources allocated to the microservice depending on the measured processing time and CPU allocation, in accordance with aspects of the present invention.

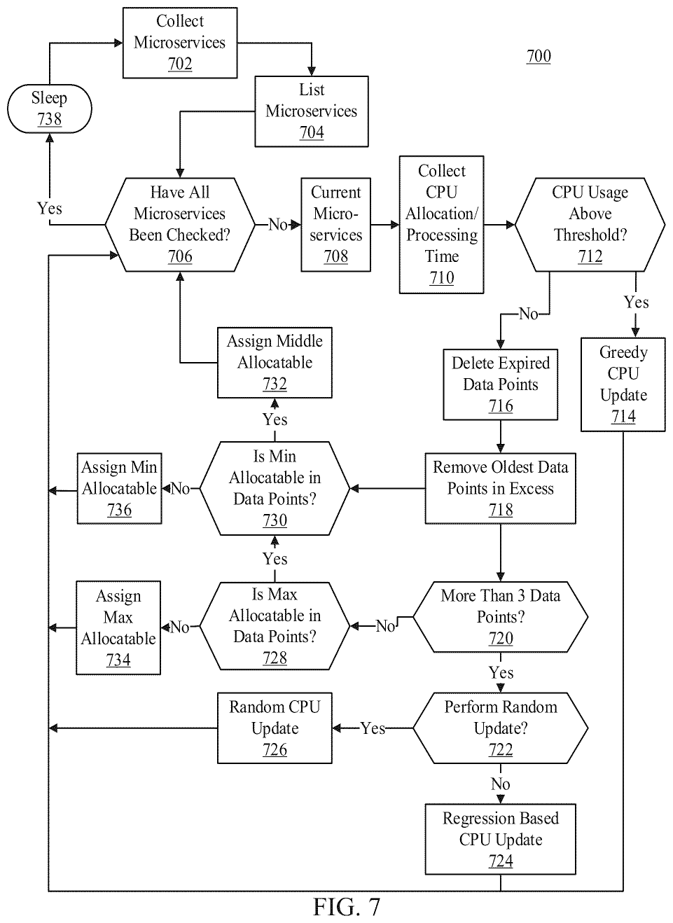

Referring now to FIG. 7, a diagram showing a method 700 for dynamically managing computing resources in a distributed microservices architecture by Latency-Aware Resource Allocation (LARA), is illustratively depicted in accordance with embodiments of the present invention.

In various embodiments, the present invention can dynamically manage and optimize CPU resources across a network of microservices within a video analytics platform. The method 700 can be utilized to optimize computational efficiency through precise monitoring, evaluation, and adjustment of resource allocations based on real-time data and historical performance metrics, in accordance with aspects of the present invention.

In various embodiments, in block 702, an extensive data collection phase where each microservice within the distributed system is identified and cataloged can be initiated. This collection process can include capturing detailed attributes of each microservice such as service architecture, operational dependencies, resource consumption patterns, current load, and historical performance metrics. This comprehensive dataset can be utilized as a basis for all subsequent resource allocation decisions and can ensure that adjustments are made with a full understanding of each microservice's role and requirements to optimize resource usage. In block 704, an organized inventory of all microservices active within the environment can be generated. This listing can include, for example, hierarchical structuring based on service function, dependency chains, priority levels, and other categorizations that facilitate efficient processing. Each microservice can be indexed with unique identifiers and linked to its specific performance and resource usage data to streamline the subsequent analysis processes.

In block 706, an evaluation of whether each microservice in the comprehensive list has been analyzed during the current evaluation cycle can be performed. This evaluation can employ a looping mechanism, which ensures that the process iterates through each microservice systematically. If any microservice has not yet been checked, the workflow can redirect to analyze that microservice, ensuring comprehensive coverage and consistent resource optimization across the board. In block 708, the specific microservice currently under review can be further processed in-depth. This can include retrieving up-to-date performance data (e.g., real-time CPU usage, memory consumption, network activity, etc.) and comparing these figures against predefined performance thresholds that dictate optimal operational parameters.

In block 710, focused data collection can be performed regarding the CPU allocation and processing times for the microservice being analyzed. Advanced data aggregation techniques can be employed to capture granular, time-series data of CPU usage patterns and processing latency, providing a detailed view of the microservice's operational efficiency and resource demands. In block 712, a decision can be made based on the current CPU usage data relative to established optimal thresholds. If the CPU usage exceeds this threshold, it can indicate potential inefficiencies or bottlenecks, prompting real-time (e.g., immediately upon detection of exceeding the threshold) automatic resource reallocation to maintain service quality and application responsiveness. In block 714, a real-time (e.g., immediately or near immediately) adjustment to the CPU allocation for the microservice can be made if the usage exceeds the critical threshold. This “greedy” approach can quickly increases resource allocation to address any urgent performance issues, ensuring that the microservice continues to meet its operational demands without delay, in accordance with aspects of the present invention.

In block 716, comparatively older and less relevant data points related to the microservice's performance can be pruned from the monitoring datasets. This ensures that decision-making is based on the most current and relevant data, enhancing the accuracy of resource allocation models and maintaining system efficiency. In block 718, the system can further refine its dataset by removing the oldest data points once they exceed a certain count or age. This process can be utilized to balance the need for historical context with the practical necessities of database management, ensuring that performance analytics are both agile and informed. In block 720, the system checks if there is a sufficient number (e.g., a predetermined or customizable threshold amount) of data points (e.g., more than 3, more than 4, etc.) post-cleanup to perform more complex statistical analyses. An appropriate minimum dataset size is utilized to ensure that any conclusions or actions based on this data are statistically valid and reliable.

In block 722, a decision point can consider whether to implement a random resource update. This can be particularly useful in situations where conventional data-driven approaches do not yield clear direction and/or when exploring new potential efficiency gains outside standard operational parameters. In block 724, if no random update is initiated, a regression-based CPU update can be performed. This sophisticated analysis can utilize statistical techniques to create a predictive model of resource needs based on existing data, which can be applied for optimizing CPU allocations to improve processing times and overall efficiency, in accordance with aspects of the present invention. In block 726, if a decision is made to proceed with a random update, this block can implement random changes in CPU allocation. This can help identify unexplored configurations that can unexpectedly improve performance, supporting a broader strategy of continuous, iterative improvement.

In block 732, for a situation for which it is determined that neither minimum nor maximum resource allocation is warranted, a median value can be assigned. This balanced approach helps stabilize microservice performance while further data is assessed, serving as a precautionary measure to maintain service levels without overcommitment of resources. In block 734, if the analysis supports a need for enhanced resources, the maximum available CPU resources can be allocated to the microservice. This action can be particularly useful, and can be reserved for situations in which peak performance is deemed critically important, such as high-load periods or when the microservice handles priority tasks.

In block 736, the minimum necessary resources can be allocated to the microservice if the data suggests it is operating above efficiency thresholds with excess resource consumption. This reduction helps optimize system-wide resource usage without compromising the fundamental operational integrity of the microservice. In block 738, after executing all checks and updates, the system can enter a sleep or idle state, where it maintains minimal activity. This resting state conserves computational resources while still allowing for basic monitoring. The system can remain in this state until the next cycle of evaluations begins, ensuring readiness to reactivate full operations as needed. During this period, minimal monitoring can continue, and major resource allocation adjustments can be paused. This can serve to reduce the computational overhead of constant monitoring and adjustment, and can provide a stabilized period for the system to operate under the newly adjusted resources before the next evaluation cycle, in accordance with aspects of the present invention.

In various embodiments, a set of strategies can be implemented to both keep microservices with sufficient CPU resources for tasks, and ensure a reduced low latency for the application by minimizing the processing time of each processing microservice. CPU usage can be checked, for either a “processing” or “non-processing” microservice, and if the measured usage is over a threshold (e.g., user set or predefined—For example, 90% of the allocated CPU), the CPU allocation can be updated. The new allocation is set to the measured “CPU usage”, and if this usage is greater than the maximum allocatable CPU on the system, the maximum allocatable amount is set as the new allocation. Then, an additional strategy can be utilized for “processing” microservices, which can include, at each iteration, collecting “CPU request” and “processing time” for each “processing” microservice. Until the collected data points are below a given, a configurable number of “exploration steps” can be performed (e.g., dividing the allocatable interval), which can include an exploratory update of the CPU allocated to the microservice, to start tracing the relationship between “CPU request” and “processing time”. Given the exploration step number n and the configurable parameters ExplorationSteps, maxAllocatable, minAllocatable, the next “CPU request” can be set as follows:

$$increment = \frac{( max Allocatable - min Allocatable )}{ExplorationSteps} \qquad [ 1 ]$$

$$r = n \% 2$$

$$q = \frac{n}{2}$$

$$newAllocation = \{ \begin{matrix}maxAllocatable - q * increment , & r = 0 \\ minAllocatable + ( r + q ) * increment , & otherwise\end{matrix} \qquad [ 2 ]$$

When the collected data points are more than the number of “exploration steps”, the present invention can switch to a processing time minimization strategy by considering “processing time” as y and “CPU request” as x, given N data point: assuming

$${y}_{j} = {b}_{1} + {b}_{2} {x}_{j} + {b}_{3} {x}_{j}^{2} + {ϵ}_{j} for j = 1 … N$$

$$Y = XB + E$$

$$Where Y = {[ {y}_{1} , {y}_{2} … {y}_{N} ]}^{T}$$

$$X = [ \begin{matrix}1 & {x}_{1} & {x}_{1}^{2} \\ ⋮ & ⋮ & ⋮ \\ 1 & {x}_{N} & {x}_{N}^{2}\end{matrix} ]$$

$$B = {[ {b}_{1} , {b}_{2} , {b}_{3} ]}^{T}$$

$$And E = {[ {ϵ}_{1} , {ϵ}_{2} … {ϵ}_{N} ]}^{T}$$

B can be estimated using quadratic polynomial regression by:

If y=ƒ(x)=b₁+b₂x+b₃x² is convex (b₃>0), and xₘᵢₙ∈Domain|ƒ(xₘᵢₙ)≤ƒ(x)∀x∈Domain, then the chosen next allocation is:

$$\{ \begin{matrix}minAllocatable , & if {x}_{min} < minAllocatable \\ maxAllocatable , & if {x}_{min} > minAllocatable \\ {x}_{min} & otherwise\end{matrix}$$

If the estimated function is not convex, the new allocation selected can be the previous CPU allocation providing the lower processing time in the collected datapoints. If the difference between the previous and the new allocation is below a threshold level (e.g., 100 millicores), the update can be discarded to promote convergence.

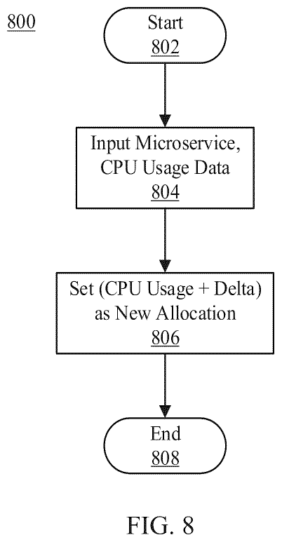

Referring now to FIG. 8, a diagram showing a method 800 for greedy CPU updating for dynamically managing computing resources within a microservice architecture, is illustratively depicted in accordance with embodiments of the present invention.

In various embodiments, in block 802, operations for dynamically adjusting computing resources within a microservice framework can be initiated. This starting point signals the beginning of a method for optimizing CPU usage based on real-time processing demands and operational conditions of computing systems. In block 804, data pertaining to a specific microservice and its current CPU usage can be received as input to the system. This data can include, for example, metrics such as current CPU load, process execution times, and any other relevant operational statistics. This information can be utilized to form the basis for decisions regarding adjustments in CPU resource allocation to ensure that the system operates within optimal parameters.

In block 806, a new, optimal CPU allocation can be determined and set by adding a delta value to the existing CPU usage. This delta can represent an adjustment factor, which can be either positive or negative, based on the analysis of current workload and performance metrics. The adjustment can be utilized to optimize resource usage by increasing or decreasing CPU allocation in response to real-time demands of the microservice. This proactive adjustment helps in maintaining efficient processing times and reducing latency in microservice responses. In block 808, the process can conclude after the new CPU allocations have been set. This endpoint marks the completion of a cycle of resource adjustment, which can be triggered again (automatically or manually) based on continuous monitoring and assessment of microservice performance and system demands. The method 800 can dynamically adjust CPU allocations to manage system resources efficiently, aiming to enhance overall performance and response times of the microservices within the operational framework, in accordance with aspects of the present invention.

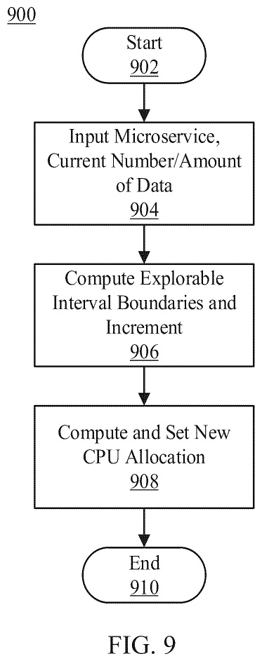

Referring now to FIG. 9, a diagram showing a method 900 for exploratory CPU updating for dynamically managing computing resources within a microservice architecture, is illustratively depicted in accordance with embodiments of the present invention.

In various embodiments, in block 902, an exploratory CPU update procedure can be initiated. This can serve as the entry point for a sequence of operations which intelligently manages CPU resources across a network of microservices by exploring potential adjustments. In block 904, relevant data about one or more specific microservices can be received as input to the system, and can include, for example, details about the microservice's current operational parameters (e.g., the number of tasks it is handling, the volume of data being processed, its present CPU usage, speed of data processing, etc.). This data can provide a snapshot of the current state of the microservice or microservices, which can be utilized for determining how CPU resources can be optimally reallocated, in accordance with aspects of the present invention.

In block 906, boundaries within which CPU allocations can be experimentally adjusted can be determined. This can include calculating a range of potential CPU allocations based on the current workload and performance metrics of the microservice. The computation can take into account both upper and lower limits to ensure that the CPU allocation remains within viable limits that do not compromise the system's stability or efficiency. The interval increments represent the steps between the minimum and maximum allocation values that can be tested to determine their impact on microservice performance.

In block 908, after identifying the exploratory interval boundaries, a new, optimal CPU allocation for one or more microservices can be computed by the system. This computation can include selecting a CPU allocation within the previously determined boundaries and incrementally adjusting it to explore its effect on performance. This can involve multiple iterations where different values within the range are tested to identify the allocation that offers the best balance between resource utilization and service performance. In block 910, the method 900 can conclude after the new CPU allocation has been set. This end step signifies that the exploratory CPU update process has completed all relevant computations and adjustments for the current cycle. These changes than be implemented (automatically or manually), and their impact on the system performance can be actively monitored, which can trigger further recommendations and adjustments based on ongoing performance assessments, in accordance with aspects of the present invention.

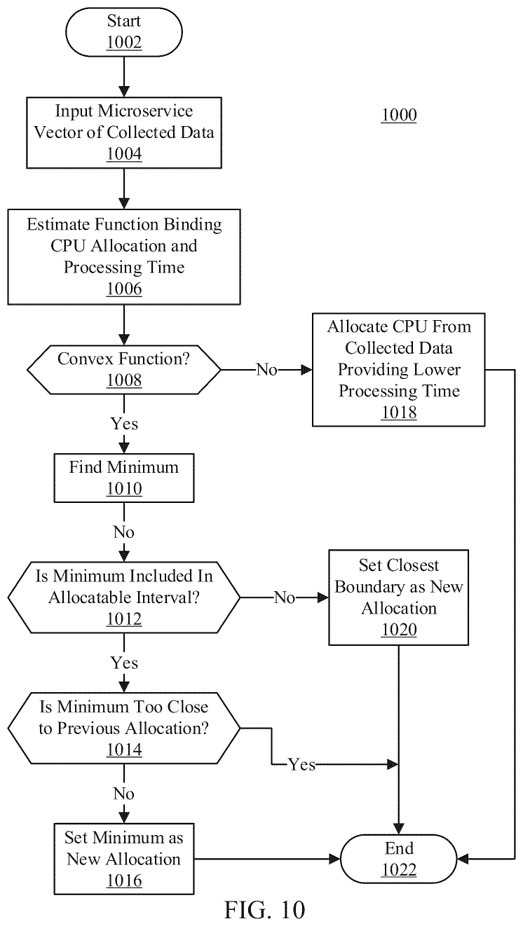

Referring now to FIG. 10, a diagram showing a method 1000 for processing time minimization and CPU allocation optimization for dynamically managing computing resources within a microservice architecture, is illustratively depicted in accordance with embodiments of the present invention. The method 1000 can include advanced data analysis techniques to dynamically adjust CPU resources in a distributed microservices architecture for optimizing CPU allocation in real-time. This method 700 can improve computational efficiency of computing systems by precisely adapting CPU allocations based on detailed performance metrics and predictive modeling.

In various embodiments, in block 1002, a sequence of operations that optimize CPU usage and allocation across various microservices can be initiated. This starting point marks the activation of the system's analysis capabilities, setting the stage for a data-driven approach to resource management. In block 1004, data pertaining to specific microservices can be collected and input into the system. This can include a wide range of performance metrics such as current CPU usage, memory usage, network traffic, and application-specific indicators such as transaction throughput or response times. The comprehensive collection of data ensures that all relevant factors are considered when determining CPU allocation needs.

In block 1006, the system can estimate a function that binds CPU allocation to processing time for each microservice based on the input data. This estimation can involve sophisticated statistical analysis and machine learning models that identify patterns and relationships within the data, providing a predictive understanding of how changes in CPU allocation can impact processing times. In block 1008, a determination can be made regarding whether the estimated function is convex. A convex function suggests that a single global minimum exists, making it possible to find the optimal point for CPU allocation that minimizes processing time. If the function is convex, the process can proceed by finding this minimum, and if not, alternative strategies can be considered. In block 1010, if the function is determined to be convex, the system can employ optimization algorithms to find the minimum point of the function. This minimum represents the optimal CPU allocation for the microservice, balancing resource usage with performance efficiency. Techniques such as gradient descent or other numerical methods can be used to accurately locate this minimum, in accordance with aspects of the present invention.

In block 1012, the system can check whether the identified minimum CPU allocation falls within a predefined allocatable interval. This interval represents the range of CPU resources that can feasibly be assigned to the microservice, taking into account system constraints and operational requirements. In block 1014, the system can evaluate whether the minimum CPU allocation is too close (e.g., below a threshold amount) to a previously allocated amount, which can indicate minimal benefit from making an adjustment. If the new allocation is determined to be too close to the current one, adjustments may be deemed unnecessary, conserving resources and reducing unnecessary system churn. In block 1016, if the identified minimum is within the allocatable interval and is sufficiently different (e.g., by a threshold amount) from the previous allocation, it can be set as the new CPU allocation for the microservice. This adjustment can be utilized to optimize the processing efficiency and overall performance of the microservice.

In block 1018, if the function is not convex, the system can instead allocate CPU based on the historical data that has shown to provide lower processing times. This approach can leverage empirical data to make informed decisions about CPU allocation when predictive modeling is inconclusive. In block 1020, if the minimum CPU allocation does not fall within permissible intervals (e.g., user set or system limitations), the system can set the closest boundary of the interval as the new allocation. This ensures that the CPU resources allocated are as close as possible to the optimal level determined by the analysis. In block 1022, the process can conclude, marking the completion of a cycle of CPU allocation optimization based on detailed analytical and empirical assessment (which can be iteratively and/or continuously performed), ensuring that the system's resources are utilized in the most efficient manner possible. The method 1000 can perform an advanced CPU allocation optimization for one of more microservices, which can incorporate both predictive and empirical data to dynamically adjust resources for optimal system performance, in accordance with aspects of the present invention.

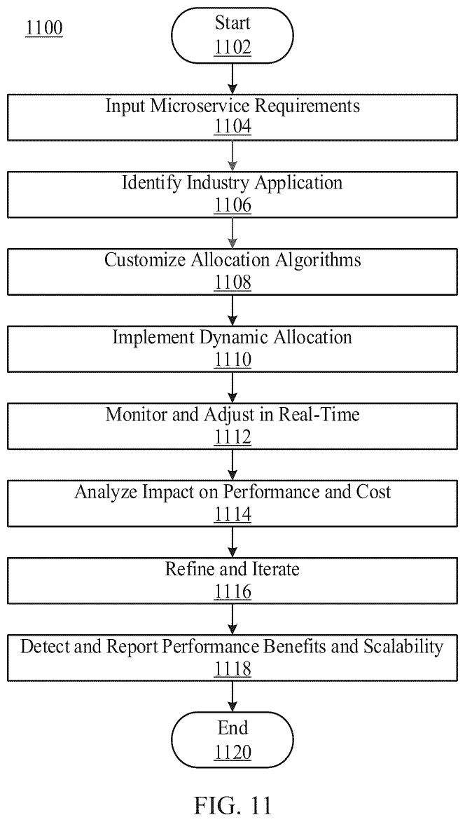

Referring now to FIG. 11 a diagram showing a high-level view of a method 1100 for dynamically optimizing allocation of CPU resources in various real-world environments responsive to specific requirements and characteristics of particular microservices, is illustratively depicted in accordance with embodiments of the present invention. The method 1100 shows various embodiments of practical applications or dynamic CPU allocations within a microservices architecture, particularly focusing on how applications in real-world scenarios.

In various embodiments, in block 1102, the process can be initiated, triggering an evaluation and deployment phases where different use cases are identified and implementation strategies are defined for subsequent execution according to the identified implementation strategies. In block 1104, specific requirements and characteristics of microservices can be received as input. This can include the operational scope, resource needs, and performance goals of microservices across different sectors such as telecommunications, financial services, or cloud computing. Understanding these parameters is particularly useful for tailoring the CPU allocation system to meet specific industry demands. In block 1106, one or more potential industry applications for the dynamic CPU allocation system can be identified for one or more physical systems. This can involve mapping out sectors where microservices are heavily utilized and where CPU resource optimization can significantly impact performance and cost-efficiency. Examples include real-time data processing in financial trading platforms or managing resource allocation in IoT (Internet of Things) networks, among others.

In block 1108, CPU allocation algorithms can be customized based on the specific needs of the identified applications. This can involve tuning parameters to handle high-volume, low-latency transactions in financial services or ensuring high availability and scalability in cloud services. The customization ensures that the algorithms are optimized for the particular characteristics and challenges of each application. In block 1110, the dynamic CPU allocation system can be implemented within the operational infrastructure of the chosen application. This can include deploying the system across the network of microservices, integrating with existing IT management platforms, and configuring the system to begin monitoring and automatically adjusting CPU resources in real-time, responsive to ongoing system optimization requirements.

In block 1112, the system can continuously monitor the performance of microservices and dynamically adjusts CPU allocations based on real-time data. This monitoring can detect fluctuations in demand, shifts in data traffic, or changes in application requirements, adjusting resources automatically to maintain optimal performance. In block 1114, the impact of dynamic CPU allocation on system performance and operational costs can be analyzed. This can involve measuring improvements in processing speeds, reductions in latency, and lower resource wastage. Additionally, cost savings from more efficient resource utilization can be quantified, providing tangible benefits to the organization. In block 1116, the CPU allocation process can be continually refined and iterated based on feedback from the ongoing operation. This iterative process ensures that the system remains efficient and effective as operational conditions evolve and new technologies emerge. Adjustments to the allocation algorithms can be made to adapt to changes in microservice architecture or to incorporate new analytical insights.

In block 1118, quantitative and qualitative benefits of the dynamic CPU allocation system can be compiled and reported to stakeholders. This can include detailed reports on performance improvements, cost savings, and enhanced service reliability. Additionally, the scalability of the system can be evaluated to determine how it can be expanded or adapted for broader or more complex applications. In block 1120, the process concludes, marking the successful deployment and integration of dynamic CPU allocation within real-world applications. The end of this process signifies a milestone in resource management optimization, showcasing the practical benefits and wide applicability of this innovative technology across various industries to improve microservice performance and operational efficiency, in accordance with aspects of the present invention.

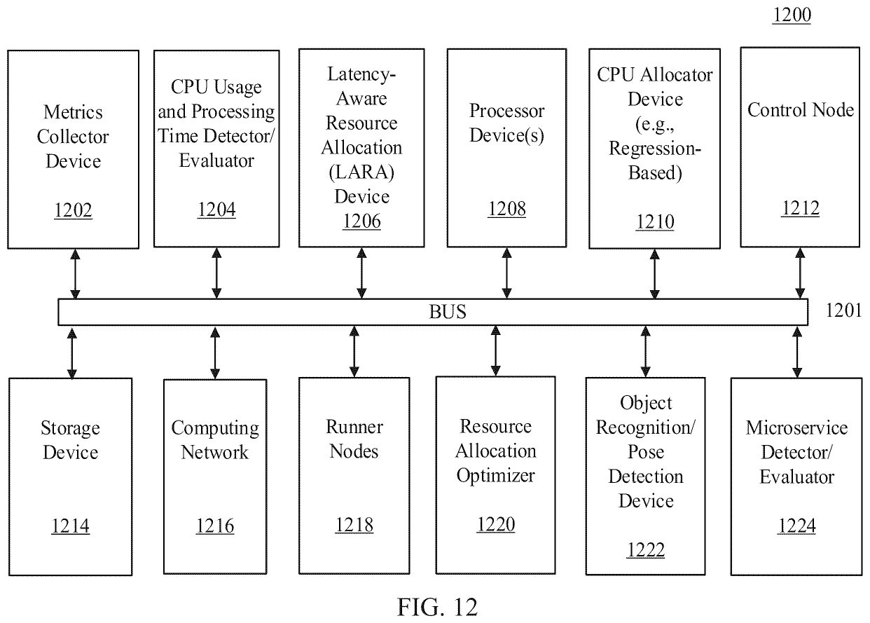

Referring now to FIG. 12 a diagram showing a high-level view of a system 1200 for dynamically monitoring and adjusting computing resource allocation within a microservice architecture, is illustratively depicted in accordance with embodiments of the present invention. The system 1200 can include a complex system architecture that integrates various specialized components designed to manage dynamic CPU allocation in a microservices environment efficiently. This system 1200 can optimize performance and resource utilization across distributed computing networks, in accordance with aspects of the present invention.

In various embodiments, in block 1202, a metrics collector device can collect real-time data on CPU usage and system performance from various parts of the microservices architecture. This component can collect and aggregate various metrics which can be utilized for assessing system health and resource demands, facilitating data-driven decision-making. In block 1204, a CPU usage and processing time detector/evaluator can analyze the metrics gathered to identify trends and potential bottlenecks in resource utilization. This device can assess the efficiency of resource usage and determine if adjustments are needed to enhance system performance.

In block 1206, a Latency-Aware Resource Allocation (LARA) device can dynamically allocate CPU resources based on current demand and system latency requirements. This component can optimize CPU distribution to minimize response times and maximize operational efficiency. In block 1208, one or more processor devices can handle the computational demands of the system, executing the algorithms and processes determined by LARA and other system components. These devices can adapt to the workload dynamically, scaling up or down based on real-time processing needs.

In block 1210, a CPU allocator device, which can be used for regression-based methods, can predict and set optimal CPU allocations for each microservice. This predictive capability can anticipate future resource requirements based on historical and current data, ensuring resources are allocated efficiently before bottlenecks occur. In block 1212, the control node can serve as the central command unit for the CPU allocation system, coordinating between various components to implement the CPU allocation strategies developed and/or utilized for the LARA and the CPU allocator devices. It can ensure that all parts of the system communicate effectively and adhere to the determined

In block 1214, a storage device can archive all operational data, including metrics, logs, and CPU usage records. This historical data can be utilized for analysis, system audits, and refining CPU allocation algorithms over time. In block 1216, a computing network can connect all system components, facilitating the rapid transfer of data and instructions across the architecture. This network ensures that data flows seamlessly. In block 1218, runner nodes can execute the microservices and applications, utilizing the CPU resources allocated to them. These nodes are where the actual data processing and task execution take place, directly impacting the system's overall performance based on their CPU efficiency.

In block 1220, a resource allocation optimizer can continuously refine the algorithms used for CPU allocation based on feedback from system performance metrics. This component ensures that the system adapts to changing conditions and improves its resource allocation strategies over time. In block 1222, an object recognition/pose detection device can process visual data to identify objects and their positions within video streams or images. This capability is particularly useful for applications requiring contextual awareness and spatial analysis, such as automated surveillance or advanced user interfaces.

In block 1224, a microservice detector/evaluator can monitor and analyze the performance and health of individual microservices within the architecture. This device ensures that each microservice is functioning optimally and flags any that require attention or adjustment in CPU allocation. In block 1201, the system integration bus acts as the communication backbone for the architecture, connecting all components. It facilitates the efficient exchange of data and control signals across the system, ensuring coherence and coordinated operations across the network, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for dynamically adjusting computing resources allocated to tasks within a stream processing application, comprising:
initiating monitoring of application-specific characteristics for each task, wherein the characteristics include at least processor (CPU) usage and processing time;
assessing resource allocation needs for each task based on the monitored characteristics to determine discrepancies between current resource allocation and optimal performance requirements;
implementing exploratory resource adjustments by incrementally modifying CPU resources allocated to a subset of tasks and analyzing an impact of the exploratory resource adjustments on task performance metrics;
determining optimal resource allocations for each task using a regression model that incorporates historical and real-time performance data;
applying the optimal resource allocations to the tasks to minimize processing time and maximize resource use efficiency; and
iteratively updating the optimal resource allocations in response to changes in task characteristics or application demands.

2. The method of claim 1, wherein the monitoring further includes tracking memory consumption and network usage of each task alongside CPU usage and processing time.

3. The method of claim 1, wherein the exploratory resource adjustments include increasing or decreasing CPU allocations in predetermined increments based on current utilization relative to a historical average, the exploratory resource adjustments being applied selectively to tasks identified as resource-intensive based on the assessing the resource allocation needs.

4. The method of claim 1, wherein the regression model used in calculating optimal resource allocation is a quadratic polynomial regression model that predicts task performance as a function of resource allocation levels, and is adapted to switch between multiple regression strategies based on a variability in performance data collected during monitoring.

5. The method of claim 1, further comprising adjusting one or more specific resource allocations responsive to detected anomalies in application performance that deviate from predefined performance thresholds.

6. The method of claim 1, further comprising validating an effectiveness of the resource adjustments by comparing pre-adjustment and post-adjustment performance metrics against predetermined benchmarks.

7. The method of claim 1, wherein the tasks are microservices in the stream processing application.

8. A system for dynamically adjusting computing resources within a stream processing application, comprising:
a processor device; and
a memory storing instructions that, when executed by the processor device, cause the system to:
monitor application-specific characteristics of each task within the application, including processing time and processor (CPU) usage;
assess resource allocation needs based on the monitored characteristics to identify under-resourced and over-resourced tasks;
implement exploratory resource adjustments to CPU resources for selected tasks and measure an impact of the exploratory resource adjustments on specified performance metrics;
determine optimal resource allocations for tasks based on a data-driven analysis incorporating results from the exploratory adjustments;
apply the optimal resource allocations to enhance task performance and resource efficiency; and
iteratively update the optimal resource allocations in response to detected changes in task-specific characteristics or application demands.

9. The system of claim 8, wherein the memory further stores instructions that cause the system to track memory bandwidth usage and network traffic as part of the task-specific characteristics.

10. The system of claim 8, wherein the exploratory resource adjustments include increasing or decreasing CPU allocations in predetermined increments based on current utilization relative to a historical average the exploratory resource adjustments being applied selectively to tasks identified as resource-intensive based on the resource allocation needs assessed.

11. The system of claim 8, wherein the data-driven analysis includes using machine learning models to predict the impact of resource changes on task performance and the machine learning models dynamically adapt to changes in data patterns from the monitored characteristics.

12. The system of claim 11, wherein the memory further stores instructions that cause the system to adjust one or more specific resource allocations responsive to detected anomalies in application performance that deviate from predefined performance thresholds.

13. The system of claim 8, wherein the memory further stores instructions that cause the system to generate alerts responsive to the performance metrics deviating more than a threshold amount from one or more benchmarks, the alerts triggering a reassessment and automatic adjustment to the determined optimal resource allocations.

14. The system of claim 8, wherein the applied optimal resource allocations are validated by comparing task performance before and after adjustments with expected performance metrics, and the determined optimal resource allocations are iteratively refined for subsequent cycles of monitoring, assessment, and adjustment based on results of the validation.

15. A computer program product for dynamically adjusting computing resources in a stream processing application, the computer program product comprising a computer-readable storage medium having program instructions embodied therewith, the program instructions executable by a hardware processor to:
monitor application-specific characteristics of each task within the application, including processing time and processor (CPU) usage;
assess resource allocation needs based on the monitored characteristics to identify under-resourced and over-resourced tasks;
implement exploratory adjustments to CPU resources for selected tasks and measure an impact of the exploratory adjustments on specified performance metrics;
determine optimal resource allocations for tasks based on a data-driven analysis incorporating results from the exploratory adjustments;
apply the optimal resource allocations to enhance task performance and resource efficiency; and
iteratively update the optimal resource allocations responsive to detected changes in task characteristics or application demands.

16. The computer program product of claim 15, where the program instructions further cause the processor to implement a feedback mechanism that adjusts the determined optimal resource allocations based on a satisfaction level of previous resource adjustments reaching a particular threshold level.

17. The computer program product of claim 15, wherein the program instructions include algorithms for incremental resource adjustments based on predefined thresholds of resource utilization.

18. The computer program product of claim 15, wherein the program instructions further cause the processor to adjust one or more specific resource allocations responsive to detected anomalies in application performance that deviate from predefined performance thresholds.

19. The computer program product of claim 15, wherein the exploratory resource adjustments include increasing or decreasing CPU allocations in predetermined increments based on current utilization relative to a historical average.

20. The computer program product of claim 15, wherein the program instructions further cause the processor to validate the applied resource allocations by comparing task performance before and after adjustments with expected performance metrics, and the determination of optimal resource allocations is iteratively refined for subsequent cycles of monitoring, assessment, and adjustment based on results of the validation.
